(19) United States
(12) Patent Application Publication
(10) Pub. No.: US 2020/0032504 A1
(43) Pub. Date: Jan. 30, 2020

(54) Movable house

(71) Applicant: Jong Woon SONG, Gwangju (KR)

(72) Inventor: Jong Woon SONG, Gwangju (KR)

(21) Appl. No.: 15/577,384

(22) PCT Filed: Nov. 10, 2016
(86) PCT No.: PCT/KR2016/012899

§ 371 Date: Nov. 28, 2017

(51) Int. Cl. E04B 1/343; E04H 1/12

(52) U.S. Cl. CPC E04B 1/3431; H02S 20/22; E04H 1/1205; E04B 1/34336

(57) ABSTRACT

Disclosed is a movable house which includes an inner house including a base, lateral walls extending upward in parallel from both ends of the base, and a roof configured to connect the lateral walls, and a light-blocking shelter unit including a lateral light-blocking member configured to block solar light by surrounding outer sides of the lateral walls of the inner house, and a roof light-blocking member extending from the lateral light-blocking member and configured to block solar light by surrounding an outer side of the roof of the inner house, wherein the light-blocking shelter unit is slid in a front-rear direction of the inner house, the base extends to a terrace formed at a front side of the inner house, and the light-blocking shelter unit is configured to secure an indoor space by being slid to the terrace.

### TECHNICAL FIELD

The present invention relates to a movable house, and more specifically, to a movable house which simultaneously allows solar light to be blocked and an extended indoor space.

### BACKGROUND ART

A movable house is a house built by pre-manufacturing all or a part of a building in a factory and transporting the pre-manufactured building to a site at which the house will be built or assembling the building at the site rather than through an existing reinforced concrete method. The movable house may be manufactured in a short period at low cost and may be also easily demolished, and thus it is preferable for the building to be used as a construction site office, a laborer's lodging, a parking management office, a restaurant, and the like in addition to an urban house. Further, the demand for leisure accommodation for outdoor activity, such as camping, has recently been gradually increased.

Typically, the movable house is positioned in an open area such as an empty lot, a parking lot, or a field, and thus, an excessive increase in an indoor temperature may be caused due to exposure thereof to solar light. Further, the movable house may be directly influenced by snow, rain, or strong winds.

Since an indoor space of the movable house is limited due to characteristics of the movable house, it is necessary for a living space thereof to be extended depending on the situation, and particularly, a terrace at a front and/or rear side of the movable house is an outdoor space but may function as an indoor space when necessary. Simultaneously, the extended indoor space may block solar light and an influence of a natural environment such as heavy rain or strong winds.

Korean Patent Registration No. 10-1346016 discloses a “tarp apparatus and modular house having the same.” The patented invention includes a tarp apparatus installed to surround an outer surface of a modular house and be moved in a front-rear direction of the modular house. The tarp apparatus is configured to lift a lifting bar with respect to a connecting bar so that a blocking member is unfolded, and thus may block rain or solar light.

However, the tarp apparatus has a very complex frame structure, and the blocking member is also made of a fiber, and thus the structure of the tarp apparatus is weak in heavy rain or strong winds. Further, the tarp apparatus places emphasis on performing functions of waterproofing and light-blocking by the blocking member being unfolded, and thus there is a limit in the extension of an indoor space to efficiently use a terrace space as described above.

Further, a movable house directly exposed to the solar light may need a design to block solar light and use the solar light as energy.

### Technical Problem

The present invention is directed to providing a movable house which allows solar light to be efficiently blocked by including a light-blocking shelter unit covering an inner house.

The present invention is directed to providing a movable house which allows solar light to be converted into electric energy by including a photovoltaic module panel in a light-blocking shelter unit.

The present invention is directed to providing a movable house which allows an indoor space is extended by moving a light-blocking shelter unit to a front and/or rear terrace of the movable house.

The present invention is directed to providing a movable house which allows an inner house heated by solar light to be cooled by including a cooling part spraying water onto a roof of the inner house.

The present invention is directed to providing a movable house which allows an indoor space to be secured while minimizing an influence of heavy rain or strong winds thereon by including a light-blocking shelter unit made of a rigid material such as metal or a synthetic resin such as polyurethane.

### Technical Solution

One aspect of the present invention provides a movable house which includes an inner house including a base, lateral walls extending upward in parallel from both ends of the base, and a roof configured to connect the lateral walls, and a light-blocking shelter unit including a lateral light-blocking member configured to block solar light by surrounding outer sides of the lateral walls of the inner house, and a roof light-blocking member extending from the lateral light-blocking member and configured to block solar light by surrounding an outer side of the roof of the inner house, wherein the light-blocking shelter unit is slid in a front-rear direction of the inner house, the base extends to a terrace formed at a front side of the inner house, and the light-blocking shelter unit is configured to secure an indoor space by being slid to the terrace.

### Advantageous Effects

Hereinafter, a movable house according to an exemplary embodiment of the present invention will be described with reference to the accompanying drawings. Prior to describing the movable house, it should be understood that detailed descriptions and configurations illustrated in the drawings of the specification are only exemplary examples of the disclosed invention. It should be understood that the invention covers various equivalents and modifications that substitute for embodiments herein and drawings at the time of filing of this application. Further, the same or similar elements in the accompanying drawings will be designated with the same numeral references.

The term “movable house” used in the specification refers to a house built by transporting a house manufactured in a factory to a site at which the house will be built or assembling all or a part of the house manufactured in the factory at the site, and includes a so-called “modular house.” Further, the movable house includes a house designed to be moved by a vehicle or other moving parts.

FIG. 1 is a schematic perspective view showing an exterior of a movable house according to one embodiment of the present invention, FIG. 2 is a schematic exploded perspective view showing a configuration of the movable house according one embodiment of the present invention. Further, FIG. 3 is a front view showing the movable house according to one embodiment of the present invention.

Referring to the drawings, the movable house according to the embodiment of the present invention includes an inner house 100 including a residential space and a light-blocking shelter unit 200 configured to surround the inner house 100 and be slid in a front-rear direction along an outer surface of the inner house 100.

The inner house 100 is limited to a residential space, for example, including a bedroom, a kitchen, a bathroom, or a space with functions thereof. However, the residential space is not particularly limited by the embodiments of the present invention as long as it includes at least one space providing at least one living function.

More specifically, the inner house 100 includes a base 110 forming a foundation of the house, lateral walls 120a and 120b extending upward in parallel from both ends of the base 110, and a roof 130 formed to connect the lateral walls 120a and 120b. A front wall 140 with a gate 141 and/or a window is installed on a front side of a space formed by the base 110, the lateral walls 120a and 120b, and the roof 130, and a rear wall (not shown) with a gate and/or a window is installed at a rear side of the space.

Spaces divided depending on necessity, such as a room, a kitchen, a bathroom, and the like, may be provided in the space formed by the base 110, the lateral walls 120a and 120b, the front/rear walls, and the roof 130.

Preferably, at least one window (not shown) may be provided on the lateral walls 120a and 120b and/or the front/rear walls.

Further, a front terrace may be formed on the front side of the inner house 100. Particularly, the front terrace represents an area extending from the gate installed on the front wall 140 toward the front side. In this case, the base 110 of the inner house 100 extends to the front terrace.

Although not shown in detail in the embodiments and the drawings, like the front terrace, a rear terrace may be formed at the rear side of the inner house 100. Particularly, the rear terrace represents an area extending from the gate installed at the rear wall of the rear terrace toward the rear side of the gate. Hereinafter, an example of only the front terrace will be described, and thus the front terrace will be referred to as a “terrace.” However, it should be understood by those of ordinary skill in the art that the same configuration may also be applied to the rear terrace.

The base 110, the lateral walls 120a and 120b, the front/rear walls, and the roof 130 of the inner house 100 may be manufactured of a metal such as a steel material, a synthetic resin such as polyurethane, wood, or a combination thereof.

Preferably, according to the embodiment of the present invention, a front end of the roof 130 extends in a direction of the terrace to form an eave 132. As described below, when the light-blocking shelter unit 200 is moved forward, the eave 132 functions as a support of the light-blocking shelter unit 200. More preferably, convenient equipment, such as lighting and the like, may be provided on the eave 132.

According to the present invention, the light-blocking shelter unit 200 is provided at an outer side of the inner house 100.

As shown in the drawings, the light-blocking shelter unit 200 includes a lateral light-blocking member 210 blocking solar light by surrounding outer sides of the lateral walls 120a and 120b of the inner house 100, and a roof light-blocking member 220 extending from the lateral light-blocking member 210 and blocking the solar light by surrounding the outside of the roof 130 of the inner house 100.

Preferably, the light-blocking shelter unit 200 may have the same shape as that of the lateral walls 120a and 120b and the roof 130 of the inner house 100. In this case, a predetermined distance is formed between the light-blocking shelter unit 200 and the inner house 100, and, as described below, the light-blocking shelter unit 200 may be configured to be moved in the front-rear direction on the outer side of the inner house 100.

According to one embodiment of the present invention, the light-blocking shelter unit 200 is formed of a rigid material, and particularly, may be formed of metal such as a steel material, a synthetic resin such as polyurethane, or a combination thereof. The light-blocking shelter unit 200 according to the present invention is formed of a steel material, and thus may efficiently block an external influence under an unfavorable condition, such as heavy rain or strong winds.

According to one embodiment of the present invention, the light-blocking shelter unit 200 is installed to be moved in the front-rear direction of the inner house 100 (that is, directions toward the front terrace and the rear terrace). To this end, a pair of lower guide rails 150 are installed on both ends of the base 110 of the inner house 100 in the front-rear direction. The lower guide rails 150 are installed to extend to an end of the base 110 forming the terrace, and thus the light-blocking shelter unit 200 may completely accommodate a terrace space.

According to one embodiment of the present invention, the lower guide rails 150 support the lateral light-blocking member 210 of the light-blocking shelter unit 200. Particularly, referring to FIG. 4 showing a partially enlarged configuration of the movable house, a plurality of rollers 212 accommodated in the lower guide rails 150 to be rolled thereon are coupled to lower ends of the lateral light-blocking member 210, and thus the lateral light-blocking member 210 may be slid in the front-rear direction along the lower guide rails 150 when the rollers 212 are operated.

In the embodiments of the present invention, examples of configurations of the lateral light-blocking member 210 and the lower guide rails 150 are particularly described, but it should be understood that the configurations are not limited thereto, and various configurations that allow the lateral member to be slid in the front-rear direction along both ends of the base 110 may be used. For example, the configuration may include a guide bar (not shown) with a slot and a sliding member (not shown) coupled to the slot to be slid therein. As another example, the configuration may include a guide member (not shown) with a guide groove and a sliding member (not shown) mounted in the guide groove.

Further, stoppers (not shown) are installed at both ends of the lower guide rails 150 to prevent the rollers 212 from escaping therefrom.

Referring to FIG. 5 showing a partially enlarged movable house according to the present invention, preferably, a pair of upper guide rails 160 extending in the front-rear direction of the roof 130 are installed on an upper surface of the roof 130 of the inner house 100 to efficiently support the light-blocking shelter unit 200 made of a rigid material and secure easier sliding thereof, and a plurality of rollers 222 mounted on the upper guide rails 160 to be rolled thereon are installed on an inner surface of the light-blocking shelter unit 200 corresponding to the upper guide rails 160.

More preferably, the upper guide rails 160 extend to the eave 132 on the upper surface of the roof 130. In this case, when the light-blocking shelter unit 200 is moved toward the terrace at an end of the roof, the upper guide rails 160 may stably support the light-blocking shelter unit 200.

Although not shown, in the movable house according to the present invention, the upper guide rails 160 are mounted on the inner surface of the light-blocking shelter unit 200 to be moved in a sliding direction of the light-blocking shelter unit 200, and the plurality of rollers 222 may be mounted on the upper surface of the roof 130 of the inner house 100 corresponding to the upper guide rails 160 when the light-blocking shelter unit is slid such that the plurality of rollers 222 are rolled along the upper guide rails 160. In this case, it is preferable for the upper guide rails 160 to be extended by an extended length of the light-blocking shelter unit 200 in the sliding direction.

According to one embodiment of the present invention, a photovoltaic module panel 300 for converting solar light into electric energy may be installed in the light-blocking shelter unit 200. Particularly, the photovoltaic module panel 300 may be coupled to a storage unit 310 formed at the lateral light-blocking member 210 of the light-blocking shelter unit 200 such that an angle thereof may be adjusted.

More particularly, referring to FIG. 3 showing a front view of the movable house according to one embodiment of the present invention, the photovoltaic module panel 300 has one end hinge-coupled to the lateral light-blocking member 210 of the light-blocking shelter unit 200 to be attached to or detached from the storage unit 310 formed at the lateral light-blocking member 210.

In this case, the photovoltaic module panel 300 is supported by a posture maintaining unit 320 to maintain a posture at a predetermined angle depending on solar light. The posture maintaining unit 320 is not particularly limited by the present invention, and may use various types of equipment supporting the photovoltaic module panel 300 with a frictional force, a hydraulic force, a pneumatic force, or an elastic force. For example, as shown in the drawing, a shock absorbing plunger has one end rotatably coupled to the lateral light-blocking member 210 of the light-blocking shelter unit 200 and the other end rotatably coupled to the photovoltaic module panel 300.

Further, the photovoltaic module panel 300 may adjust the angle thereof by being manually operated and, as an alternative, may be designed so that a driving part automatically adjusts the angle of the photovoltaic module panel 300.

The configuration and operation of the photovoltaic module panel 300, which is a system configured to generate power using solar light, are already known, and thus detailed descriptions thereof will be omitted.

According to one embodiment of the present invention, the photovoltaic module panel 300 may be installed on the roof light-blocking member 220 in addition to on the lateral light-blocking member 210. In this case, the photovoltaic module panel 300 installed on the roof light-blocking member 220 may also be configured such that the angle thereof is manually or automatically adjusted depending on solar light.

Although not shown in the drawings, an opening is formed in the lateral light-blocking member 210, and the photovoltaic module panel 300 may be installed in the opening such that an inclination thereof is adjusted by being detached from the opening. In this case, when the photovoltaic module panel 300 is adjusted to be inclined, the opening is opened to function as a ventilation hole for the indoor space.

The movable house according to one embodiment of the present invention includes a cooling part for controlling an indoor temperature by cooling the inner house 100. A schematic configuration of the cooling part is shown in FIG. 6.

Referring to FIG. 6 and the above-described drawings, the cooling part includes a water spraying part installed on the upper surface of the roof 130 of the inner house 100, a water tank 170 for storing water to be supplied thereto, and a pump P configured to provide power for supplying the water in the water tank 170 to the water spraying part.

For example, the water spraying part includes a flowing water hose 172 installed along the upper surface of the roof 130 of the inner house 100, and a spray nozzle 174 formed at a lateral side of the flowing water hose 172 (see FIG. 5). Therefore, the pump P is operated to supply the water stored in the water tank 170 to the flowing water hose 172, and the water is sprayed through the spray nozzle 174 to cool the roof 130) of the inner house 100.

As an alternative, the cooling part may include a plurality of water jet devices (not shown) or a sprinkler (not shown) installed on the roof 130 of the inner house 100.

As another alternative, referring to FIG. 9, the water spraying part further includes an auxiliary flowing water hose 172′ installed on an upper surface of the light-blocking shelter unit 200) to extend in a sliding direction of the light-blocking shelter unit 200 and made of a bendable material so that interference with the sliding of the light-blocking shelter unit 200 is not caused, and the spray nozzle 174 formed at a lateral surface of the auxiliary flowing water hose 172′. The auxiliary flowing water hose 172′ may be connected with the flowing water hose 172 and may be directly connected with the water tank 170. Therefore, the water introduced into the auxiliary flowing water hose 172′ is sprayed through the spray nozzle 174 to cool the roof of the light-blocking shelter unit 200.

Water is manually sprayed by the cooling part according to the present invention or may be automatically sprayed by a temperature sensor and a control unit, which are not shown.

An operation of the movable house according to one embodiment of the present invention having the above configuration will be described with reference to FIG. 7 and the above-described drawings. FIG. 7 is a schematic perspective view showing a state in which the light-blocking shelter unit 200 of the movable house according to one embodiment of the present invention is moved to the front terrace.

As shown in FIG. 1, the movable house according to one embodiment of the present invention may block solar light by allowing the light-blocking shelter unit 200 to surround the outer surface of the inner house 100. In this case, when the indoor temperature of the inner house 100 is increased due to excessive exposure to solar light, the cooling part is operated to spray water onto the upper surface of the roof 130 of the inner house 100 through the spray nozzle 174.

The photovoltaic module panel 300 may covert solar light into electric energy, and the electric energy generated in the conversion process may be stored in a battery, which is not shown, or used for various electric devices in the inner house 100.

The posture maintaining unit 320 is appropriately formed to adjust the inclination of the photovoltaic module panel 300 to more efficiently convert solar light into power.

When a user uses a terrace of the inner house 100 as an indoor space, as shown in FIG. 7, the light-blocking shelter unit 200 may be moved to the front side of the inner house 100. The light-blocking shelter unit 200 may be manually moved or automatically moved by a separate driving part.

When the light-blocking shelter unit 200 is moved to the front side of the inner house 100, the roof light-blocking member 220 and the lateral light-blocking member 210 of the light-blocking shelter unit 200 are supported by the upper guide rails 160 and the lower guide rails (150), respectively. That is, the plurality of rollers 222 installed on the inner surface of the roof light-blocking member 220 are rolled along upper surfaces of the upper guide rails 160, and the plurality of rollers 222 installed at lower ends of the lateral light-blocking member 210 are rolled while accommodated in the lower guide rails 150. Thus, as shown in FIG. 7, the light-blocking shelter unit 200 is moved forward to the end of the terrace, that is, the end of the base 110 of the inner house 100. In this case, the upper guide rails 160 extend to the eave 132 of the inner house 100, and thus the light-blocking shelter unit 200 may be more stably supported.

As shown in FIG. 7, when the light-blocking shelter unit 200 is moved forward to the front end of the base 110, a user may use the terrace as an indoor space. According to the movable house of the present invention, the light-blocking shelter unit 200 is made of a rigid material such as a steel material or a synthetic resin, and thus the terrace space may be efficiently used even in the event of heavy rain or strong winds. The use of the terrace space may be further maximized when movable houses according to the embodiment of the present invention face each other.

FIG. 8 is a schematic side view showing a state in which movable houses according to one embodiment of the present invention are disposed to face each other and light-blocking shelters thereof are connected.

As shown in the drawing, when gates of the two movable houses face each other and each of light-blocking shelter units 200 is slid to the end of the base 110 so that the light-blocking shelter units 200 are connected, a wider indoor space between the movable houses may be secured, and thus user convenience may be increased.

In this case, a gate 230 (see FIG. 2) may be selectively further provided on the lateral light-blocking member 210 of the light-blocking shelter unit 200 to allow a user to access to the indoor space secured by the light-blocking shelter unit 200.

Although the embodiments of the present invention have been described in detail with reference to the accompanying drawings, the technological scope of the present invention is determined by claims, and various equivalents and modifications may be made without departing from the scope of the technological spirit of the present invention.

### DESCRIPTION OF DRAWINGS

Although the present invention is described in detail by the following drawings, the drawings show embodiments of the present invention, and thus it should be understood that the technical sprit of the present invention is not limited to the drawings.

FIG. 1 is a schematic perspective view showing an exterior of a movable house according to one embodiment of the present invention.

FIG. 2 is a schematic exploded perspective view showing a configuration of the movable house according one embodiment of the present invention.

FIG. 3 is a front view showing the movable house according to one embodiment of the present invention.

FIG. 4 is a partially enlarged view of the movable house according to one embodiment of the present invention.

FIG. 5 is a partially enlarged view of the movable house according to one embodiment of the present invention.

FIG. 6 is a view for describing a cooling unit provided in the movable house according to one embodiment of the present invention.

FIG. 7 is a schematic perspective view showing a state in which a light-blocking shelter of the movable house according to one embodiment of the present invention is moved to a front terrace.

FIG. 8 is a schematic side view showing a state in which movable houses according to one embodiment of the present invention are disposed to face each other and light-blocking shelters thereof are connected.

FIG. 9 is a schematic perspective view showing an exterior of the movable house according to one embodiment of the present invention.

### MODES OF THE INVENTION

Hereinafter, a movable house according to an exemplary embodiment of the present invention will be described with reference to accompanying drawings. Prior to describing the movable house, it should be understood that detailed descriptions and configurations illustrated in drawings of the specification are only exemplary examples of the disclosed invention. It should be understood that the invention covers various equivalents and modifications that substitute for the embodiments herein and drawings at the time of filing of this application. Further, the same or similar elements in the accompanying drawings will be designated with the same numeral references.

The term “movable house” used in the specification refers to a house built by transporting a house manufactured in a factory to a site at which the house will be built or assembling all or a part of the house manufactured in the factory at the site, and includes a so-called “modular house.” Further, the movable house includes a house designed to be moved by a vehicle or other moving parts.

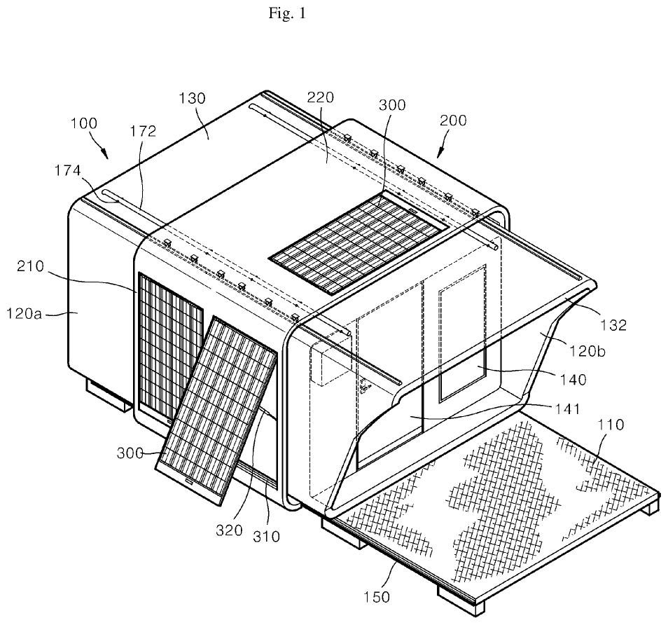

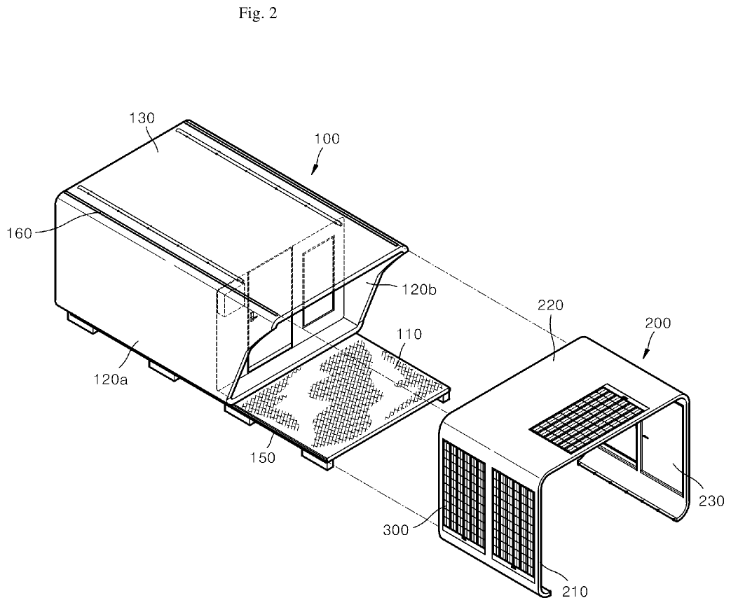

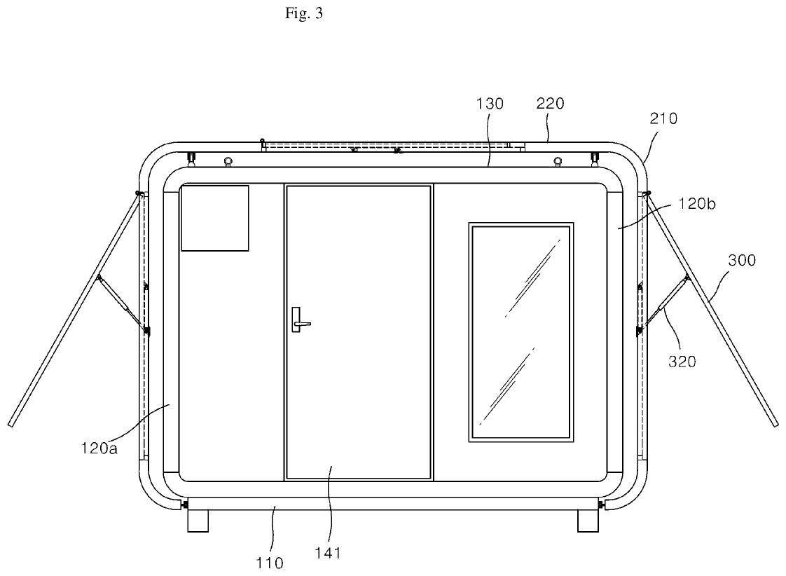

FIG. 1 is a schematic perspective view showing an exterior of a movable house according to one embodiment of the present invention, FIG. 2 is a schematic exploded perspective view showing a configuration of the movable house according one embodiment of the present invention. Further, FIG. 3 is a front view showing the movable house according to one embodiment of the present invention.

Referring to the drawings, the movable house according to the embodiment of the present invention includes an inner house 100 including a residential space and a light-blocking shelter unit 200 configured to surround the inner house 100 and be slid in a front-rear direction along an outer surface of the inner house 100.

The inner house 100 is limited to a residential space, for example, including a bedroom, a kitchen, a bathroom, or a space with functions thereof. However, the residential space is not particularly limited by the embodiments of the present invention as long as it includes at least one space providing at least one living function.

More specifically, the inner house 100 includes a base 110 forming a foundation of the house, lateral walls 120a and 120b extending upward in parallel from both ends of the base 110, and a roof 130 formed to connect the lateral walls 120a and 120b. A front wall 140 with a gate 141 and/or a window is installed on a front side of a space formed by the base 110, the lateral walls 120a and 120b, and the roof 130, and a rear wall (not shown) with a gate and/or a window is installed at a rear side of the space.

Spaces divided depending on necessity, such as a room, a kitchen, a bathroom, and the like, may be provided in the space formed by the base 110, the lateral walls 120a and 120b, the front/rear walls, and the roof 130.

Preferably, at least one window (not shown) may be provided on the lateral walls 120a and 120b and/or the front/rear walls.

Further, a front terrace may be formed on the front side of the inner house 100. Particularly, the front terrace represents an area extending from the gate installed on the front wall 140 toward the front side. In this case, the base 110 of the inner house 100 extends to the front terrace.

Although not shown in detail in the embodiments and the drawings, like the front terrace, a rear terrace may be formed at the rear side of the inner house 100. Particularly, the rear terrace represents an area extending from the gate installed at the rear wall of the rear terrace toward the rear side of the gate. Hereinafter, an example of only the front terrace will be described, and thus the front terrace will be referred to as a “terrace.” However, it should be understood by those of ordinary skill in the art that the same configuration may also be applied to the rear terrace.

The base 110, the lateral walls 120a and 120b, the front/rear walls, and the roof 130 of the inner house 100 may be manufactured of a metal such as a steel material, a synthetic resin such as polyurethane, wood, or a combination thereof.

Preferably, according to the embodiment of the present invention, a front end of the roof 130 extends in a direction of the terrace to form an eave 132. As described below, when the light-blocking shelter unit 200 is moved forward, the eave 132 functions as a support of the light-blocking shelter unit 200. More preferably, convenient equipment, such as lighting and the like, may be provided on the eave 132.

According to the present invention, the light-blocking shelter unit 200 is provided at an outer side of the inner house 100.

As shown in the drawings, the light-blocking shelter unit 200 includes a lateral light-blocking member 210 blocking solar light by surrounding outer sides of the lateral walls 120a and 120b of the inner house 100, and a roof light-blocking member 220 extending from the lateral light-blocking member 210 and blocking the solar light by surrounding the outside of the roof 130 of the inner house 100.

Preferably, the light-blocking shelter unit 200 may have the same shape as that of the lateral walls 120a and 120b and the roof 130 of the inner house 100. In this case, a predetermined distance is formed between the light-blocking shelter unit 200 and the inner house 100, and, as described below, the light-blocking shelter unit 200 may be configured to be moved in the front-rear direction on the outer side of the inner house 100.

According to one embodiment of the present invention, the light-blocking shelter unit 200 is formed of a rigid material, and particularly, may be formed of metal such as a steel material, a synthetic resin such as polyurethane, or a combination thereof. The light-blocking shelter unit 200 according to the present invention is formed of a steel material, and thus may efficiently block an external influence under an unfavorable condition, such as heavy rain or strong winds.

According to one embodiment of the present invention, the light-blocking shelter unit 200 is installed to be moved in the front-rear direction of the inner house 100 (that is, directions toward the front terrace and the rear terrace). To this end, a pair of lower guide rails 150 are installed on both ends of the base 110 of the inner house 100 in the front-rear direction. The lower guide rails 150 are installed to extend to an end of the base 110 forming the terrace, and thus the light-blocking shelter unit 200 may completely accommodate a terrace space.

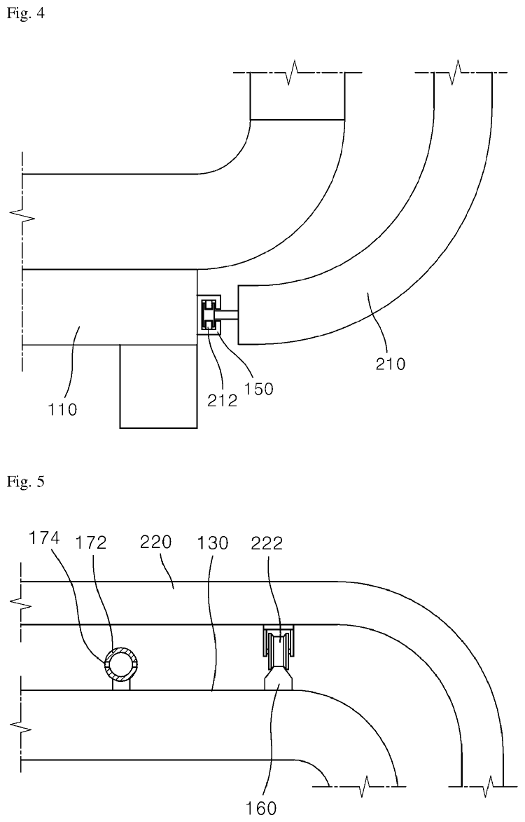

According to one embodiment of the present invention, the lower guide rails 150 support the lateral light-blocking member 210 of the light-blocking shelter unit 200. Particularly, referring to FIG. 4 showing a partially enlarged configuration of the movable house, a plurality of rollers 212 accommodated in the lower guide rails 150 to be rolled thereon are coupled to lower ends of the lateral light-blocking member 210, and thus the lateral light-blocking member 210 may be slid in the front-rear direction along the lower guide rails 150 when the rollers 212 are operated.

In the embodiments of the present invention, examples of configurations of the lateral light-blocking member 210 and the lower guide rails 150 are particularly described, but it should be understood that the configurations are not limited thereto, and various configurations that allow the lateral member to be slid in the front-rear direction along both ends of the base 110 may be used. For example, the configuration may include a guide bar (not shown) with a slot and a sliding member (not shown) coupled to the slot to be slid therein. As another example, the configuration may include a guide member (not shown) with a guide groove and a sliding member (not shown) mounted in the guide groove.

Further, stoppers (not shown) are installed at both ends of the lower guide rails 150 to prevent the rollers 212 from escaping therefrom.

Referring to FIG. 5 showing a partially enlarged movable house according to the present invention, preferably, a pair of upper guide rails 160 extending in the front-rear direction of the roof 130 are installed on an upper surface of the roof 130 of the inner house 100 to efficiently support the light-blocking shelter unit 200 made of a rigid material and secure easier sliding thereof, and a plurality of rollers 222 mounted on the upper guide rails 160 to be rolled thereon are installed on an inner surface of the light-blocking shelter unit 200 corresponding to the upper guide rails 160.

More preferably, the upper guide rails 160 extend to the eave 132 on the upper surface of the roof 130. In this case, when the light-blocking shelter unit 200 is moved toward the terrace at an end of the roof, the upper guide rails 160 may stably support the light-blocking shelter unit 200.

Although not shown, in the movable house according to the present invention, the upper guide rails 160 are mounted on the inner surface of the light-blocking shelter unit 200 to be moved in a sliding direction of the light-blocking shelter unit 200, and the plurality of rollers 222 may be mounted on the upper surface of the roof 130 of the inner house 100 corresponding to the upper guide rails 160 when the light-blocking shelter unit is slid such that the plurality of rollers 222 are rolled along the upper guide rails 160. In this case, it is preferable for the upper guide rails 160 to be extended by an extended length of the light-blocking shelter unit 200 in the sliding direction.

According to one embodiment of the present invention, a photovoltaic module panel 300 for converting solar light into electric energy may be installed in the light-blocking shelter unit 200. Particularly, the photovoltaic module panel 300 may be coupled to a storage unit 310 formed at the lateral light-blocking member 210 of the light-blocking shelter unit 200 such that an angle thereof may be adjusted.

More particularly, referring to FIG. 3 showing a front view of the movable house according to one embodiment of the present invention, the photovoltaic module panel 300 has one end hinge-coupled to the lateral light-blocking member 210 of the light-blocking shelter unit 200 to be attached to or detached from the storage unit 310 formed at the lateral light-blocking member 210.

In this case, the photovoltaic module panel 300 is supported by a posture maintaining unit 320 to maintain a posture at a predetermined angle depending on solar light. The posture maintaining unit 320 is not particularly limited by the present invention, and may use various types of equipment supporting the photovoltaic module panel 300 with a frictional force, a hydraulic force, a pneumatic force, or an elastic force. For example, as shown in the drawing, a shock absorbing plunger has one end rotatably coupled to the lateral light-blocking member 210 of the light-blocking shelter unit 200 and the other end rotatably coupled to the photovoltaic module panel 300.

Further, the photovoltaic module panel 300 may adjust the angle thereof by being manually operated and, as an alternative, may be designed so that a driving part automatically adjusts the angle of the photovoltaic module panel 300.

The configuration and operation of the photovoltaic module panel 300, which is a system configured to generate power using solar light, are already known, and thus detailed descriptions thereof will be omitted.

According to one embodiment of the present invention, the photovoltaic module panel 300 may be installed on the roof light-blocking member 220 in addition to on the lateral light-blocking member 210. In this case, the photovoltaic module panel 300 installed on the roof light-blocking member 220 may also be configured such that the angle thereof is manually or automatically adjusted depending on solar light.

Although not shown in the drawings, an opening is formed in the lateral light-blocking member 210, and the photovoltaic module panel 300 may be installed in the opening such that an inclination thereof is adjusted by being detached from the opening. In this case, when the photovoltaic module panel 300 is adjusted to be inclined, the opening is opened to function as a ventilation hole for the indoor space.

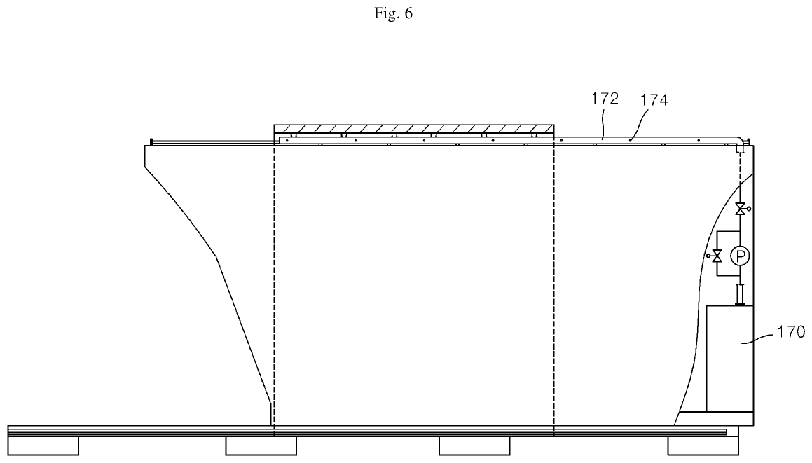

The movable house according to one embodiment of the present invention includes a cooling part for controlling an indoor temperature by cooling the inner house 100. A schematic configuration of the cooling part is shown in FIG. 6.

Referring to FIG. 6 and the above-described drawings, the cooling part includes a water spraying part installed on the upper surface of the roof 130 of the inner house 100, a water tank 170 for storing water to be supplied thereto, and a pump P configured to provide power for supplying the water in the water tank 170 to the water spraying part.

For example, the water spraying part includes a flowing water hose 172 installed along the upper surface of the roof 130 of the inner house 100, and a spray nozzle 174 formed at a lateral side of the flowing water hose 172 (see FIG. 5). Therefore, the pump P is operated to supply the water stored in the water tank 170 to the flowing water hose 172, and the water is sprayed through the spray nozzle 174 to cool the roof 130) of the inner house 100.

As an alternative, the cooling part may include a plurality of water jet devices (not shown) or a sprinkler (not shown) installed on the roof 130 of the inner house 100.

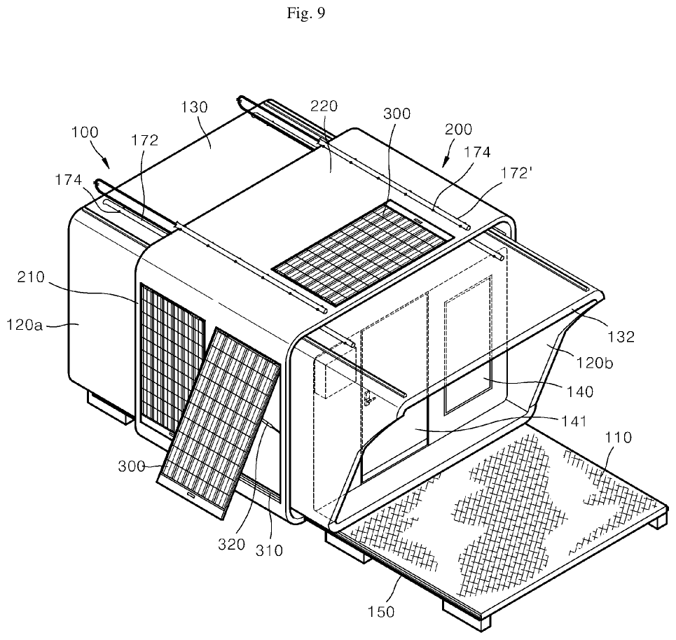

As another alternative, referring to FIG. 9, the water spraying part further includes an auxiliary flowing water hose 172′ installed on an upper surface of the light-blocking shelter unit 200) to extend in a sliding direction of the light-blocking shelter unit 200 and made of a bendable material so that interference with the sliding of the light-blocking shelter unit 200 is not caused, and the spray nozzle 174 formed at a lateral surface of the auxiliary flowing water hose 172′. The auxiliary flowing water hose 172′ may be connected with the flowing water hose 172 and may be directly connected with the water tank 170. Therefore, the water introduced into the auxiliary flowing water hose 172′ is sprayed through the spray nozzle 174 to cool the roof of the light-blocking shelter unit 200.

Water is manually sprayed by the cooling part according to the present invention or may be automatically sprayed by a temperature sensor and a control unit, which are not shown.

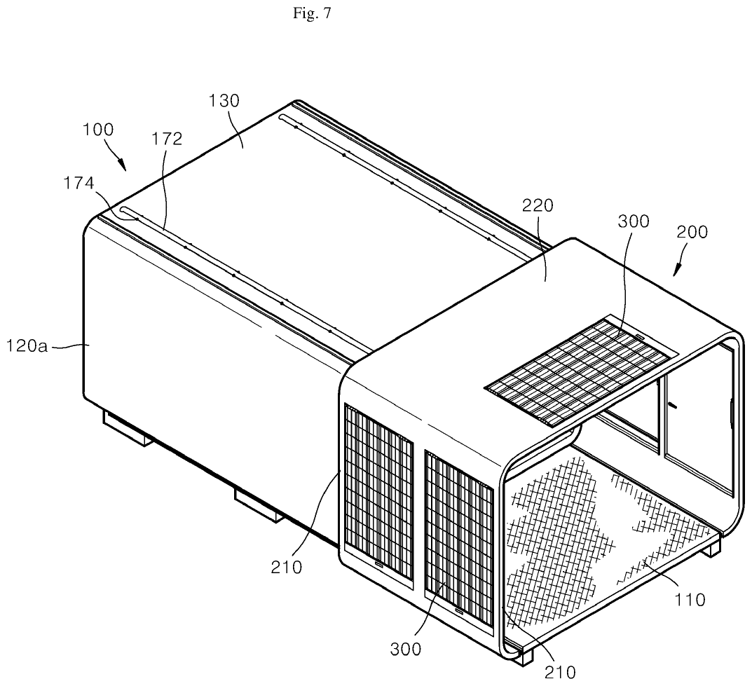

An operation of the movable house according to one embodiment of the present invention having the above configuration will be described with reference to FIG. 7 and the above-described drawings. FIG. 7 is a schematic perspective view showing a state in which the light-blocking shelter unit 200 of the movable house according to one embodiment of the present invention is moved to the front terrace.

As shown in FIG. 1, the movable house according to one embodiment of the present invention may block solar light by allowing the light-blocking shelter unit 200 to surround the outer surface of the inner house 100. In this case, when the indoor temperature of the inner house 100 is increased due to excessive exposure to solar light, the cooling part is operated to spray water onto the upper surface of the roof 130 of the inner house 100 through the spray nozzle 174.

The photovoltaic module panel 300 may covert solar light into electric energy, and the electric energy generated in the conversion process may be stored in a battery, which is not shown, or used for various electric devices in the inner house 100.

The posture maintaining unit 320 is appropriately formed to adjust the inclination of the photovoltaic module panel 300 to more efficiently convert solar light into power.

When a user uses a terrace of the inner house 100 as an indoor space, as shown in FIG. 7, the light-blocking shelter unit 200 may be moved to the front side of the inner house 100. The light-blocking shelter unit 200 may be manually moved or automatically moved by a separate driving part.

When the light-blocking shelter unit 200 is moved to the front side of the inner house 100, the roof light-blocking member 220 and the lateral light-blocking member 210 of the light-blocking shelter unit 200 are supported by the upper guide rails 160 and the lower guide rails (150), respectively. That is, the plurality of rollers 222 installed on the inner surface of the roof light-blocking member 220 are rolled along upper surfaces of the upper guide rails 160, and the plurality of rollers 222 installed at lower ends of the lateral light-blocking member 210 are rolled while accommodated in the lower guide rails 150. Thus, as shown in FIG. 7, the light-blocking shelter unit 200 is moved forward to the end of the terrace, that is, the end of the base 110 of the inner house 100. In this case, the upper guide rails 160 extend to the eave 132 of the inner house 100, and thus the light-blocking shelter unit 200 may be more stably supported.

As shown in FIG. 7, when the light-blocking shelter unit 200 is moved forward to the front end of the base 110, a user may use the terrace as an indoor space. According to the movable house of the present invention, the light-blocking shelter unit 200 is made of a rigid material such as a steel material or a synthetic resin, and thus the terrace space may be efficiently used even in the event of heavy rain or strong winds. The use of the terrace space may be further maximized when movable houses according to the embodiment of the present invention face each other.

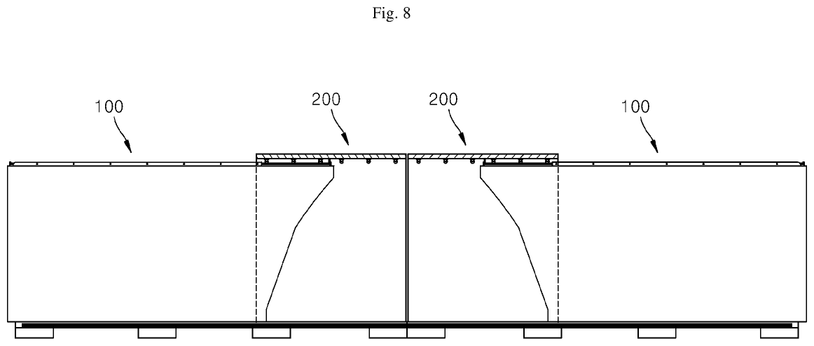

FIG. 8 is a schematic side view showing a state in which movable houses according to one embodiment of the present invention are disposed to face each other and light-blocking shelters thereof are connected.

As shown in the drawing, when gates of the two movable houses face each other and each of light-blocking shelter units 200 is slid to the end of the base 110 so that the light-blocking shelter units 200 are connected, a wider indoor space between the movable houses may be secured, and thus user convenience may be increased.

In this case, a gate 230 (see FIG. 2) may be selectively further provided on the lateral light-blocking member 210 of the light-blocking shelter unit 200 to allow a user to access to the indoor space secured by the light-blocking shelter unit 200.

Although the embodiments of the present invention have been described in detail with reference to the accompanying drawings, the technological scope of the present invention is determined by claims, and various equivalents and modifications may be made without departing from the scope of the technological spirit of the present invention.

1. A movable house comprising:
an inner house including a base, lateral walls extending upward in parallel from both ends of the base, and a roof configured to connect the lateral walls; and
a light-blocking shelter unit including a lateral light-blocking member configured to block solar light by surrounding outer sides of the lateral walls of the inner house, and a roof light-blocking member extending from the lateral light-blocking member and configured to block solar light by surrounding an outer side of the roof of the inner house, wherein the light-blocking shelter unit is slid in a front-rear direction of the inner house,
wherein the base extends to a terrace formed at a front side of the inner house, and the light-blocking shelter unit is configured to secure an indoor space by being slid to the terrace.

2. The movable house of claim 1, further comprising:
a pair of lower guide rails installed on both ends of the base in the front-rear direction; and
a plurality of rollers coupled to lower ends of the lateral light-blocking member to be accommodated in the lower guide rails.

3. The movable house of claim 2, wherein the lower guide rails are installed to extend to an end of the base forming the terrace.

4. The movable house of claim 2, further comprising:
a pair of upper guide rails installed to extend in the front-rear direction on an upper surface of the roof of the inner house; and
a plurality of rollers installed on an inner surface of the light-blocking shelter unit to be mounted on the upper guide rails.

5. The movable house of claim 4, wherein the upper guide rails are formed to extend to an eave of the roof extending and protruding in a terrace direction.

6. The movable house of claim 1, wherein the light-blocking shelter unit is made of a rigid material including a metal or a synthetic resin.

7. The movable house of claim 1, wherein the light-blocking shelter unit includes a photovoltaic module panel configured to convert solar light into electric energy.

8. The movable house of claim 7, wherein the photovoltaic module panel is coupled to the lateral light-blocking member of the light-blocking shelter unit to allow an angle thereof to be adjusted.

9. The movable house of claim 1, further comprising:
a water spraying part installed at an upper surface of the roof of the inner house;
a water tank configured to store water to be supplied to the water spraying part; and
a pump configured to provide power for supplying the water in the water tank to the water spraying part.

10. The movable house of claim 1, wherein the lateral light-blocking member of the light-blocking shelter unit further includes a gate.
